(19) United States
(12) Patent Application Publication
(10) Pub. No.: US 2010/0060176 A1
(43) Pub. Date: Mar. 11, 2010

(54) DISPLAY APPARATUS

(75) Inventors: Toshiro Takahashi, Kanagawa-ken (JP); Yasuhiro Seto, Kanagawa-ken (JP)

Correspondence Address: Studebaker & Brackett PC, One Fountain Square, 11911 Freedom Drive, Suite 750, Reston, VA, 20190, US

(73) Assignee: FUJIFILM CORPORATION, Tokyo (JP)

(21) Appl. No.: 12/555,278

(22) Filed: Sep. 8, 2009

(30) Foreign Application Priority Data
Sep. 9, 2008 (JP) 230407/2008

(51) Int. Cl. G09G 3/06

(52) U.S. Cl. 315/169.3

(57) ABSTRACT

A display apparatus, including an active matrix substrate with an array of multiple pixel circuits, each having a light emitting element, a drive transistor connected to the light emitting element to apply a drive current to the light emitting element, a capacitor element connected between a gate terminal and the source terminal of the drive transistor, and a selection transistor connected between the gate terminal of the drive transistor and a data line through which a predetermined data signal flows, in which the drive transistor is an n-type thin film transistor having a current characteristic in which a drive current at a gate-source voltage Vgs=0V corresponds to an average drive current Idavr.

### BACKGROUND OF THE INVENTION

1. Field of the Invention

The present invention relates to a display apparatus having a light emitting element driven by an active matrix method.

2. Description of the Related Art

Display devices using light emitting elements, such as organic EL elements, for use in various applications, including televisions, cell phone displays, and the like, have been proposed.

Generally, organic EL elements are current driven light emitting elements and, unlike a liquid crystal display, require, as minimum, selection transistors for selecting pixel circuits, holding capacitors for holding charges according to an image to be displayed, and drive transistors for driving the organic EL elements as the drive circuit as described, for example, U.S. Pat. No. 5,684,365 (Patent Document 1).

Heretofore, thin film transistors of low-temperature polysilicon or amorphous silicon have been used in pixel circuits of active matrix organic EL display devices.

The low-temperature polysilicon thin film transistor may provide high mobility and stability of threshold voltage, but has a problem that the mobility is not uniform. The amorphous silicon thin film transistor may provide uniform mobility, but has a problem that the mobility is low and threshold voltage varies with time.

The non-uniform mobility and instable threshold voltage appear as irregularities in the displayed image. Consequently, for example, Japanese Unexamined Patent Publication No. 2003-255856 (Patent Document 2) proposes a display device in which a compensation circuit of diode connection method is provided in the pixel circuit.

The provision of the compensation circuit described in Patent Document 2, however, causes the pixel circuit to become complicated, resulting in increased cost due to low yield rate and low aperture ratio.

As such, for example, Japanese Unexamined Patent Publication No. 2003-271095 (Patent Document 3) proposes a method for correcting the threshold voltage of the drive transistor by charging a parasitic capacitance of the organic EL element and reducing the number of transistors used in the pixel circuit.

In the pixel circuit described in Patent Document 3, it is necessary to use an n-type thin film transistor as the drive transistor, and the use of an amorphous silicon thin film transistor is envisaged as the n-type thin film transistor.

The amorphous silicon thin film transistor, however, poses a problem that the threshold voltage is shifted by bias temperature stress due to gate voltage application.

Further, the pixel circuit described in Patent Document 3 has a configuration in which the anode terminal of the organic EL element is connected to the source terminal of the drive transistor, and a capacitor element for detecting the threshold voltage is provided between the gate and source of the drive transistor. In this configuration, the threshold voltage of the drive transistor is held by the capacitor element by applying a predetermined fixed voltage to the gate terminal of the drive transistor to apply a detection current and charging the parasitic capacitance of the organic EL element by the detection current.

Therefore, in order to charge the parasitic capacitance without causing the organic EL element to emit light, it is necessary to set the source terminal voltage Vs of the drive transistor (anode terminal voltage of the organic EL element) lower than emission threshold voltage Vf0 of the organic EL element, as illustrated in FIG. 16. Source terminal Voltage Vs of the drive transistor is determined by the magnitude of the threshold voltage of the drive transistor (minimum value Vthmin to maximum value Vthmax of the threshold value), as illustrated in FIG. 16, so that, when the threshold voltage is shifted by the bias temperature stress, accurate detection and normal correction of the threshold voltage will become impossible and the quality of a displayed image will be degraded. In FIG. 16, VB denotes a fixed voltage applied to the gate terminal of the drive transistor, and ΔVth denotes the magnitude of the variation in the threshold voltage of the drive transistor.

Consequently, Japanese Unexamined Patent Publication No. 2006-227237 (Patent Document 4) proposes a method for preventing a threshold voltage shift of the drive transistor by applying voltage Vg lower than source voltage Vs of the drive transistor to the gate terminal to apply a reverse bias to the drive transistor immediately before a reset period in which data held in the pixel circuit is reset.

The magnitude of gate voltage Vg applied to the gate terminal of the drive transistor when displaying an image depends on the image, and the amount of shift in the threshold voltage of the drive transistor varies with the magnitude of gate voltage Vg. In contrast, the reverse bias period and magnitude of reverse bias voltage in Patent Document 4 are common to all pixels. Therefore, the method can not cover the difference in threshold voltage of individual drive transistors and the difference in shift amount of threshold voltage of drive transistors when an image is displayed. Then, once threshold voltage shift starts out in the drive transistor due to insufficiency of reverse bias, the threshold voltage is shifted at an accelerated pace. That is, it is difficult for the method described in Patent document 4 to prevent threshold voltage shift in the drive transistor when the display image is updated over a long period of time.

In view of the circumstances described above, it is an object of the present invention to provide a display apparatus capable of preventing threshold voltage shift of the drive transistors and stably correcting threshold voltage variations of the drive transistors over a long period of time.

### SUMMARY OF THE INVENTION

A display apparatus of the present invention is an apparatus, including an active matrix substrate with an array of multiple pixel circuits, each having a light emitting element, a drive transistor connected to the light emitting element to apply a drive current to the light emitting element, a capacitor element connected between a gate terminal and a source terminal of the drive transistor, and a selection transistor connected between the gate terminal of the drive transistor and a data line for feeding a predetermined data signal, in which the drive transistor is an n-type thin film transistor having a current characteristic in which a drive current at a gate-source voltage Vgs=0V corresponds to an average drive current.

The display apparatus of the present invention may further include a data drive circuit for supplying data signals to the gate terminal of the drive transistor, the signals including both a signal that causes the Vgs of the drive transistor to be positive and a signal that causes the Vgs of the drive transistor to be negative.

Further, data drive circuit may be a circuit that supplies a fixed voltage to the gate terminal of the drive transistor, and a threshold voltage of the drive transistor may be held by the capacitor element by charging a parasitic capacitance of the light emitting element by a current flowed through the drive transistor by the supply of the fixed voltage of the data drive circuit.

Still further, the average drive current may be 15 to 50% of a drive current of the drive transistor when the light emitting element is at maximum luminance.

Further, the drive transistor may be an n-type thin film transistor of IGZO (InGaZnO).

Still further, a transistor having a negative turn-off threshold voltage may be used as the drive transistor and a transistor having a positive turn-off threshold voltage may be used as the selection transistor.

Further, the source terminal of the drive transistor may be connected to an anode terminal of the light emitting element.

According to the display apparatus of the present invention, the apparatus includes an active matrix substrate with an array of multiple pixel circuits, each having a light emitting element, a drive transistor connected to the light emitting element to apply a drive current to the light emitting element, a capacitor element connected between a gate terminal and a source terminal of the drive transistor, and a selection transistor connected between the gate terminal of the drive transistor and a data line for feeding a predetermined data signal, and an n-type thin film transistor having a current characteristic in which a drive current at a gate-source voltage Vgs=0 corresponds to an average drive current is used as the drive transistor. This will result in that both a positive voltage and a negative voltage are applied as Vgs at the time of emission operation, so that even when the display is updated over a long period of time, Vgs is equalized between positive and negative voltages, resulting in substantially a zero bias state. Thus, threshold voltage shift in the drive transistors may be effectively prevented, and threshold voltage variations may be corrected appropriately, whereby a high quality image display without display irregularities may be realized.

Further, when the average drive current is set to 15 to 50% of a drive current of the drive transistor when the light emitting element is at maximum luminance, it matches with an average luminance of a general natural image, so that threshold voltage shift in the drive transistors may be prevented effectively.

When an n-type thin film transistor of IGZO is used as the drive transistor, the reversible threshold voltage shift of n-type thin film transistor of IGZO can be used. That is, the threshold voltage of the n-type thin film transistor of IGZO may also be shifted by the voltage stress due to the application of gate voltage, but unlike an amorphous silicon thin film transistor, the threshold voltage returns to the initial value by applying zero bias for a long time. For example, even when an image having a unique gray balance, unlike a natural image, such as PC screen, CG image, or the like, is displayed for a long period of time and the balance in Vgs between positive/negative biases is disrupted, whereby threshold voltage shift occurs, the utilization of this property allows the threshold voltage to be returned to the initial value during a non-display period, so that the threshold voltage shift may be prevented.

### BRIEF DESCRIPTION OF THE DRAWINGS

FIG. 1 is a schematic configuration diagram of an organic EL display device incorporating a first embodiment of the display apparatus of the present invention.

FIG. 2 illustrates a configuration of a pixel circuit of the organic EL display device incorporating the first embodiment of the display apparatus of the present invention.

FIG. 3 is a graph illustrating a current characteristic of the drive transistor of the pixel circuit shown in FIG. 2.

FIG. 4 is a timing chart illustrating an operation of the organic EL display device incorporating the first embodiment of the display apparatus of the present invention.

FIG. 5 illustrates a reset operation of the organic EL display device according to the first embodiment.

FIG. 6 illustrates a threshold voltage detection operation of the organic EL display device according to the first embodiment.

FIG. 7 illustrates a program operation of the organic EL display device according to the first embodiment.

FIG. 8 illustrates an emission operation of the organic EL display device according to the first embodiment.

FIG. 9 is a schematic configuration diagram of an organic EL display device incorporating a second embodiment of the display apparatus of the present invention.

FIG. 10 illustrates a configuration of a pixel circuit of the organic EL display device incorporating the second embodiment of the display apparatus of the present invention.

FIG. 11 is a timing chart illustrating an operation of the organic EL display device incorporating the second embodiment of the display apparatus of the present invention.

FIG. 12 illustrates a reset operation of the organic EL display device according to the second embodiment.

FIG. 13 illustrates a threshold voltage detection operation of the organic EL display device according to the second embodiment.

FIG. 14 illustrates a program operation of the organic EL display device according to the second embodiment.

FIG. 15 illustrates an emission operation of the organic EL display device according to the second embodiment.

FIG. 16 illustrates the relationship between source voltage Vs of a drive transistor and the emission threshold voltage of the organic EL element in threshold voltage detection operation.

### DESCRIPTION OF THE PREFERRED EMBODIMENTS

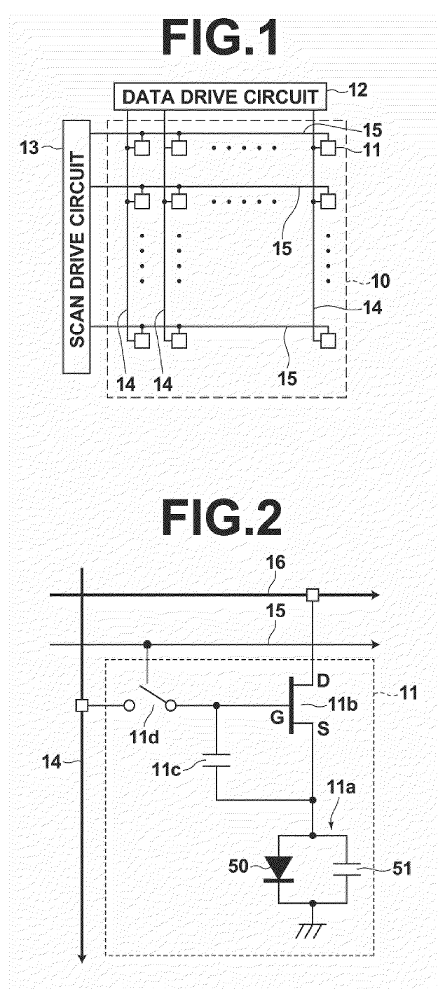

Hereinafter, an organic EL display device incorporating a first embodiment of the display apparatus of the present invention will be described with reference to the accompanying drawings. FIG. 1 is a schematic configuration diagram of the organic EL display device incorporating the first embodiment of the display apparatus of the present invention.

As illustrated in FIG. 1, the organic EL display device according to the first embodiment of the present invention includes active matrix substrate 10 having multiple pixel circuits 11 disposed thereon two-dimensionally, each for holding charges according to a data signal outputted from data drive circuit 12 and applying a drive current through an organic EL element according to the amount of charges held therein, data drive circuit 12 that outputs a data signal to each pixel circuit 11 of the active matrix substrate 10, and scan drive circuit 13 that outputs a scan signal to each pixel circuit 11 of the active matrix substrate 10.

Active matrix substrate 10 further includes multiple data lines 14, each for supplying the data signal outputted from data drive circuit 12 to each pixel circuit column and multiple scan lines 15, each for supplying the scan signal outputted from scan drive circuit 13 to each pixel circuit row. Data lines 14 and scan lines 15 are orthogonal to each other, forming a grid pattern. Each pixel circuit 11 is provided adjacent to the intersection between each data line and scan line.

As illustrated in FIG. 2, each pixel circuit 11 includes organic EL element 11a, drive transistor 11b with source terminal S connected to the anode terminal of organic EL element 11a to apply a drive current and a detection current, to be described later, to organic EL element 11a, capacitor element 11c connected between gate terminal G and source terminal S of drive transistor 11b, and selection transistor 11d connected between one end of capacitor element 11c/gate terminal G of drive transistor 11b and data line 14.

Organic EL element 11a includes emission section 50 that emits light according to the drive current applied by drive transistor 11b and parasitic capacitance 51 of emission section 50. The cathode terminal of organic EL element 11a is connected to the ground potential.

Drive transistor 11b and selection transistor 11d are n-type thin film transistors. As for the type of thin film transistor used for drive transistor 11b, an inorganic oxide thin film transistor having so-called normally-on characteristic, i.e., with a negative turn-off threshold voltage is preferably used. As for the inorganic oxide thin film transistor, for example, a thin film transistor of inorganic oxide film of IGZO (InGaZnO) may be used, but the material is not limited to IGZO, and IZO (InZnO) and the like may also be used. As for selection transistor 11d, a thin film transistor having so-called normally-off characteristics in which the turn-off threshold voltage is a positive voltage is used.

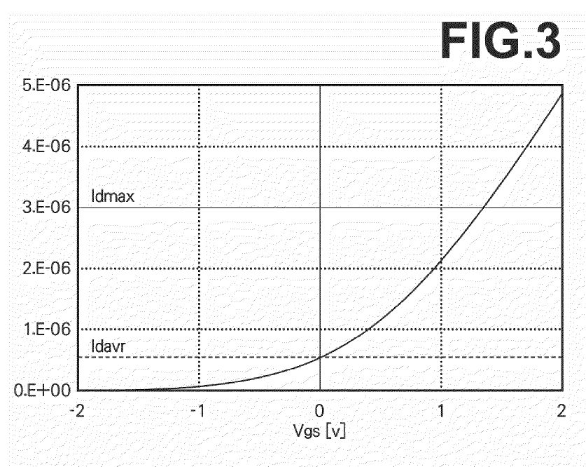

Further, as for drive transistor 11b, a transistor having a current characteristic like that shown in FIG. 3 is used. In FIG. 3, Vgs, Id, Idmax, and Idavr respectively represent gage-source voltage, drive current, maximum drive current, and average drive current of drive transistor 11b. That is, a drive transistor having a current characteristic in which a drive current at Vgs=0V corresponds to an average drive current with a negative turn-off threshold voltage is used as drive transistor 11b.

As illustrated in FIG. 2, drain terminal D of drive transistor 11b is connected to power line 16. Power line supplies predetermined power source voltage Vddx to drive transistor 11b.

Scan drive circuit 13 sequentially outputs ON-scan signal Vscan (on)/OFF-scan signal Vscan(off) to each scan line 15 for turning ON/OFF selection transistor 11d of pixel circuit 11.

Data drive circuit 12 outputs data signals, which include data bus signal VB and program data signal Vprg based on a display image, to each data line 14. Output timings, functions, and magnitude conditions of these data signals will be described in detail later.

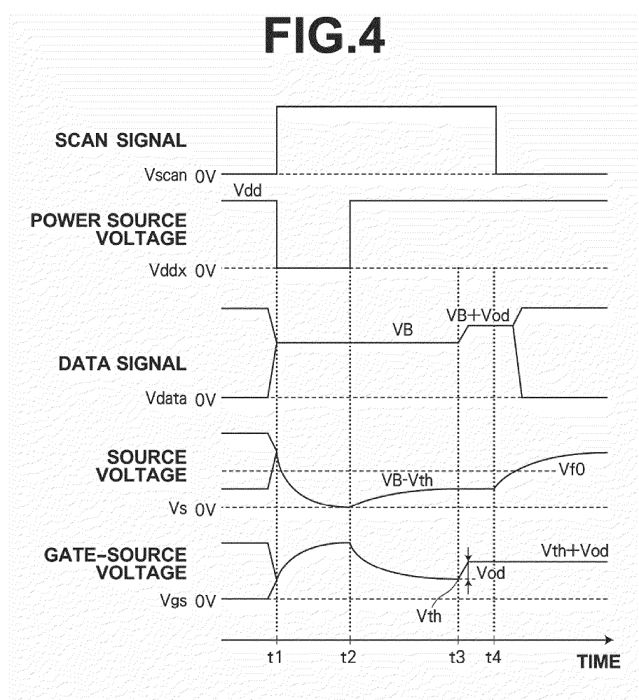

An operation of the organic EL display device of the present embodiment will now be described with reference to the timing chart shown in FIG. 4 and FIGS. 5 to 8. FIG. 4 shows voltage waveforms of scan signal Vscan, power source voltage Vddx, data signal Vdata, source voltage Vs, and gate-source voltage Vgs.

In the organic EL display device of the present embodiment, pixel circuit rows connected to respective scan lines 15 of active matrix substrate 10 are sequentially selected and predetermined operation steps are performed with respect to each pixel circuit row within a selected period. Here, the operation steps performed in a selected pixel circuit row within a selected period will be described.

First, a certain pixel circuit row is selected by scan drive circuit 13, and an ON-scan signal like that shown in FIG. 4 is outputted to scan line 15 connected to the selected pixel circuit row (time point t1 in FIG. 4).

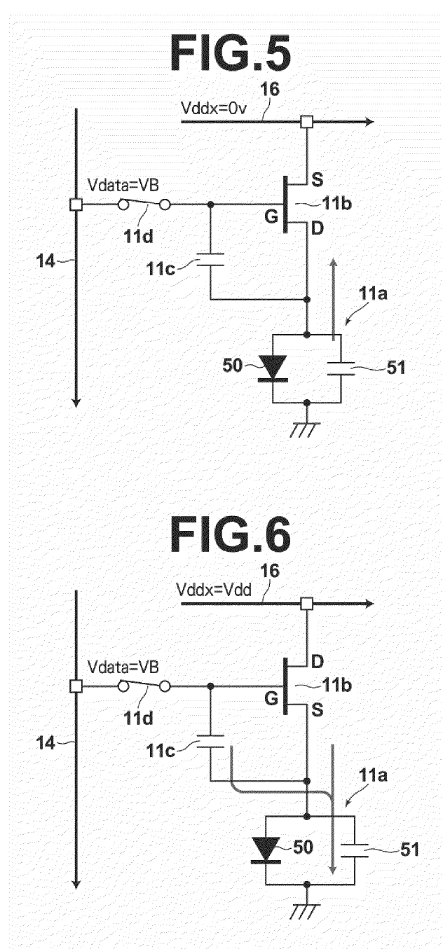

Then, as illustrated in FIG. 5, selection transistor 11d is turned ON in response to the ON-scan signal outputted from scan drive circuit 13, and gate terminal G of drive transistor 11b and data line 14 are short circuited.

Then, resetting is performed first (t1 to t2 in FIG. 4 and FIG. 5).

More specifically, data bus signal VB is outputted from data drive circuit 12 to each data line 14.

Here, if the emission threshold voltage of organic EL element and the threshold voltage of drive transistor 11b are assumed to be Vf0 and Vth, data bus signal VB needs to satisfies the formula below. That is, although drive transistor 11b is turned on by the supply of data bus signal, organic EL element 11a does not emit light because data bus signal VB is smaller than Vf0+Vth.

Vth<VB<Vf0+Vth

Data bus signal VB outputted from data drive circuit 12 is inputted to each pixel circuit 11 in the selected pixel circuit row.

Here, the time immediately preceding the reset operation is an emission period of each pixel circuit 11 in the pixel circuit low, so that a certain amount of charges remains in parasitic capacitance 51 of organic EL element 11a.

Then, when the power source voltage Vddx of power line 16 is changed from Vdd to 0V, the terminal of drive transistor 11b on the side of organic EL element 11a becomes drain terminal D and the terminal on the side of power line 16 becomes source terminal S, and the charges remaining in parasitic capacitance 51 of organic EL element 11a are discharged to power line 16 via the source-drain of drive transistor 11b, whereby the potential of the anode terminal of organic EL element 11a eventually becomes 0V.

Then, a threshold voltage detection operation is performed (t2 to t3 in FIG. 4 and FIG. 6).

More specifically, power source voltage Vddx is restored to Vdd, whereby the terminal on the side of power line 16 becomes drain terminal D and the terminal of drive transistor 11b on the side of organic EL element 11a becomes source terminal S.

Here, data bus signal VB is supplied to gate terminal G of drive transistor 11b so that Vgs>Vth and detection current Idd flows through drive transistor 11b according to Vgs. Then, parasitic capacitance 51 of organic EL element is charged by detection current Idd, and source voltage Vs at source terminal S of drive transistor 11b is increased.

Data bus signal VB supplied to gate terminal G of drive transistor 11b is a fixed voltage, so that Vgs is decreased by the increase in source voltage Vs and detection current Idd is decreased.

Then, the detection current of drive transistor 11b eventually ceases to flow at the time point when source voltage Vs=VB−Vth (time point t3 in FIG. 4).

Here, terminal voltage Vcs of capacitor element 11c is,

Vcs=Vg−Vs=VB−(VB−Vth)=Vth,

thus, threshold voltage Vth of drive transistor 11b is maintained.

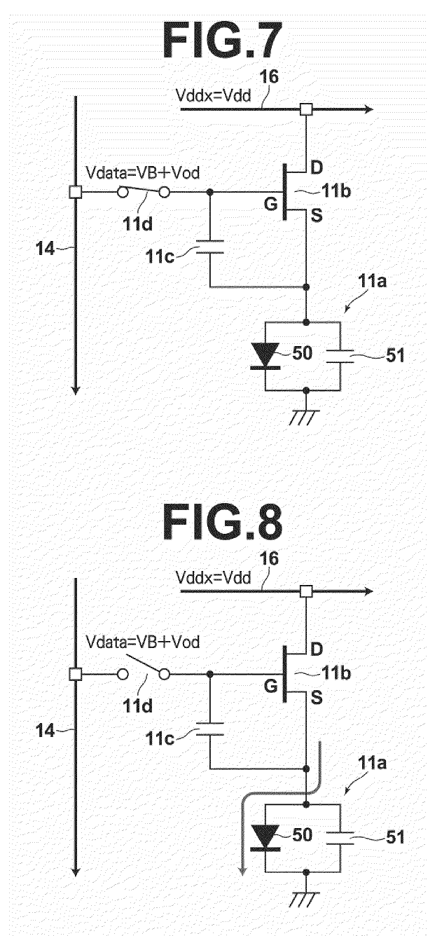

Next, a program operation is performed (t3 to t4 in FIG. 4 and FIG. 7).

More specifically, program data signal Vprg is outputted from data drive circuit 12 to each data line 14. Program data signal Vprg outputted from data drive circuit 12 is inputted to each pixel circuit 11 in the selected pixel circuit row.

Here, program data signal Vprg is,

Vprg=VB+Vod,

where Vod is an overdrive voltage of drive transistor 11b, Vod=Vgs−Vth. Note that Vod is a voltage value signal having a magnitude based on a display image. That is, a voltage value signal having a magnitude corresponding to a desired emission amount of organic EL element 11a.

When program data signal Vprg that satisfies the formula above, source voltage Vs of drive transistor 11b is divided by capacitance Cs of capacitor element 11c and capacitance Cd of parasitic capacitance 51 of organic EL element 11a, so that Vs=(VB−Vth)+Vod×{Cs/(Cd+Cs)}, but if Cs <<Cd, then Vod×{Cs/(Cd+Cs)≈0, thus, Vs≈VB−Vth. Therefore, a voltage substantially corresponding to threshold voltage Vth detected by the threshold voltage detection operation plus Vod is set to capacitor element 11c.

Data drive circuit 12 of the present embodiment is a circuit that supplies both program data signals that cause gate-source voltage Vgs of drive transistor 11b to be positive and negative. That is, the program data signals set when program operation is performed include positive and negative voltages. Thus, when the program data signal is updated many times over a long period of time, the gate-source voltage is equalized between positive and negative sides, resulting in substantially a zero biased state. This may effectively prevent the shift in threshold voltage Vth of drive transistor 11b, whereby a high quality image display without display irregularities may be realized.

Then, an emission operation is performed (t4 onward in FIG. 4 and FIG. 8). More specifically, an OFF-scan signal is outputted from scan drive circuit 13 to each scan line 15 (time point t4 in FIG. 4).

Then, as illustrated in FIG. 8, selection transistor 11d is turned OFF in response to the OFF-scan signal outputted from scan drive circuit 13, and gate terminal G of drive transistor 11b is disconnected from data line 14.

Then, gate-source voltage Vgs of drive transistor 11b becomes Vod+Vth, and drive current Idv flows between the drain and source of drive transistor 11b according to the TFT current formula below.

$$\begin{matrix}Idv = μ \times Cox \times ( W \text{/} L ) \times {( Vgs - Vth )}^{2} \\ = μ \times Cox \times ( W \text{/} L ) \times {Vod}^{2}\end{matrix}$$

where, μ is the electron mobility, Cox is the gate oxide film capacitance per unit area, W is the gate width, and L is the gate length.

Parasitic capacitance 51 of organic EL element 11a is charged by drive current Idv, and source voltage Vs of drive transistor 11b is increased, but gate-source voltage Vgs is maintained at Vod+Vth held by capacitor element 11c, so that source voltage Vs exceeds, in due time, emission threshold voltage Vf0 of organic EL element 11a and an emission operation under a constant current is performed by emission section 50 of organic EL element 11a.

After application of Vod is completed, it is necessary to turn OFF selection transistor 11d by outputting an OFF-scan signal from scan drive circuit 13 to each scan line 15 before source voltage Vs is increased by the increase in the terminal voltage of parasitic capacitance 51 of organic EL element 11a by drive current Idv applied between the drain and source of drive transistor 11b.

Thereafter, pixel circuit rows are sequentially selected by scan drive circuit 13, and the operation steps from resetting to light emission are performed in each pixel circuit row, whereby a desired image is displayed.

In the organic EL display device of the present embodiment, a drive transistor having a current characteristic in which a drive current at Vgs=0 corresponds to an average drive current is used as drive transistor 11b. Preferably, the average drive current is 15% to 50% of the drive current of drive transistor 11b when the organic EL element 11a is at maximum luminance.

Some of the recent display devices have an automatic luminance control function for controlling luminance according to an image to be displayed. For example, paper “Ergonomics Requirements for Flat Panel Displays”, S. Kubota, p. 12, Ergonomics Symposium on Flat Panel Displays (FPD) 2008, JEITA (Japan Electronics and Information Technology Industries Association) describes that display luminance control according to average data of an image to be displayed is effective. That is, the overall luminance is increased for images of low average data, such as image 1 (average data=4.35) to image 3 (average data=11.53) and decreased for images of high average data, such as image 9 (average data=92.46).

As the result, it is presumed that the average luminance will be forced to the same level as image 4 (average data=12.19) to image 8 (average data=43.26).

Hence, it is preferable that the average drive current is set to 15% to 50% of the drive current of the drive transistor when the organic EL element is at maximum luminance.

Preferably, the average drive current is set to about 20% of the drive current of the drive transistor when the organic EL element is at maximum luminance for displaying a moving picture, because the average luminance of a moving picture is about 20% as described, for example, in a paper at Fifth Meeting of Energy Saving Standard Subcommittee, Advisory Committee on Natural Resources and Energy.

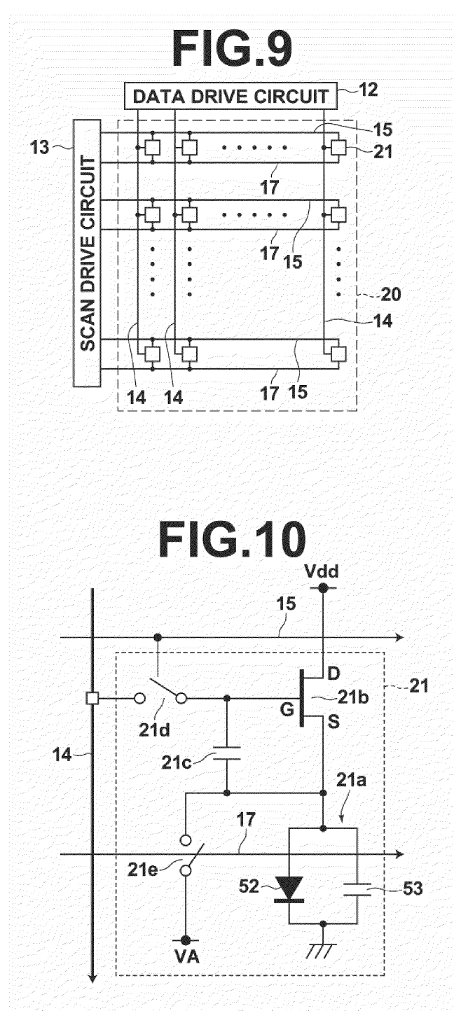

Next, an organic EL display device incorporating a second embodiment of the display apparatus of the present invention will be described. FIG. 9 is a schematic configuration diagram of the organic EL display device incorporating the second embodiment of the display apparatus of the present invention. FIG. 10 is a configuration diagram of pixel circuit 21 according to the second embodiment.

As illustrated in FIG. 9, the organic EL display device of the second embodiment further includes multiple reset scan lines 17 for supplying reset signal Vres outputted from scan drive circuit 13 to each pixel circuit row.

Pixel circuit 21 according to the second embodiment further has a threshold voltage correction function by self charging of the drive transistor. More specifically, as illustrated in FIG. 10, pixel circuit 21 includes organic EL element 21a, drive transistor 21b with source terminal S connected to the anode terminal of organic EL element 21a to apply a drive current to organic EL element 21a, capacitor element 21c connected between gate terminal G and source terminal S of drive transistor 21b, selection transistor 21d connected between gate terminal G of drive transistor 21b and data line 14, and reset transistor 21e connected to the source terminal of drive transistor 21b.

Organic EL element 21a includes emission section 52 that emits light according to the drive current applied by drive transistor 21b and parasitic capacitance 52 of emission section 52. The cathode terminal of organic EL element 21a is connected to the ground potential.

Drive transistor 21b, selection transistor 11d, and reset transistor 21e are n-type thin film transistors. As for the type of thin film transistor used for drive transistor 21b, an inorganic oxide thin film transistor with a negative turn-off threshold voltage is used, as in the first embodiment. As for the inorganic oxide thin film transistor, for example, a thin film transistor of inorganic oxide film of IGZO (InGaZnO) may be used, but the material is not limited to IGZO, and IZO (InZnO) and the like may also be used. As for drive transistor 21b, a transistor having a current characteristic like that shown in FIG. 3 is used.

As illustrated in FIG. 10, pixel circuit 21 is configured such that fixed voltage Vdd is supplied to drain terminal D of drive transistor 21b and fixed voltage VA is supplied to source terminal S of drive transistor 21b via reset transistor 21e.

As in the first embodiment, scan drive circuit 13 sequentially outputs ON-scan signal Vscan(on) and OFF-scan signal Vscan(off) to each scan line 15. Further, scan drive circuit 13 sequentially outputs ON-reset signal Vres(on)/OFF-reset signal Vres(off) for turning ON/OFF reset transistor 21e of each pixel circuit 21.

Data drive circuit 12 is identical to that of the first embodiment.

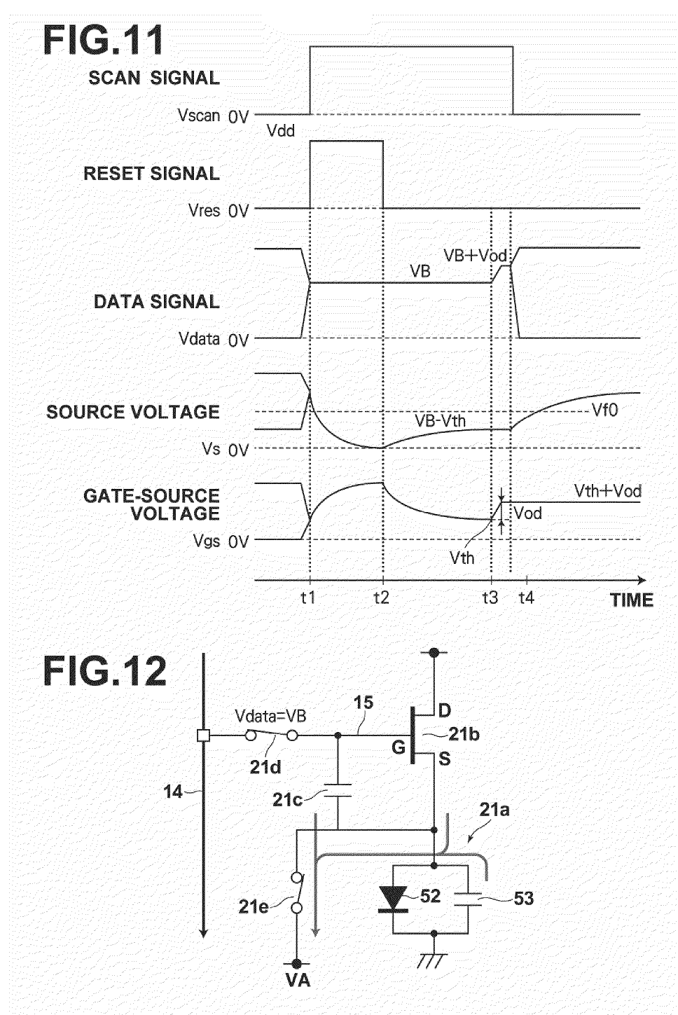

An operation of organic EL display device of the present embodiment will now be described with reference to the timing chart in FIG. 11 and FIGS. 12 to 15. FIG. 11 shows voltage waveforms of scan signal Vscan, reset signal Vres, data signal Vdata, source voltage Vs, and gate-source voltage Vgs.

As in the first embodiment, also in the second embodiment, pixel circuit rows connected to respective scan lines 15 of active matrix substrate 10 are sequentially selected and predetermined operation steps are performed with respect to each pixel circuit row within a selected period. Here, the operation steps performed in a selected pixel circuit row within a selected period will be described.

First, a certain pixel circuit row is selected by scan drive circuit 13, and an ON-scan signal like that shown in FIG. 11 is outputted to scan line 15 connected to the selected pixel circuit row and an ON-reset signal like that shown in FIG. 11 is outputted to reset scan line 17 connected to the selected pixel circuit row.

Then, as illustrated in FIG. 12, selection transistor 21d is turned ON in response to the ON-scan signal outputted from scan drive circuit 13, whereby gate terminal G of drive transistor 21b and data line 14 are short circuited, and reset transistor 21e is turned ON in response to the ON-reset signal outputted from scan drive circuit 13, whereby source terminal S of drive transistor 21b and the fixed voltage source are short circuited, and fixed voltage VA is supplied to source terminal S of drive transistor 21b.

Then, resetting is performed first (t1 to t2 in FIG. 11 and FIG. 12).

More specifically, data bus signal VB is outputted from data drive circuit 12 to each data line 14. This causes gate voltage Vg of drive transistor 21b to be set to VB, Vg=VB, and source voltage Vs of drive transistor 21b to be set to VA, Vs=VA, thus gate-source voltage Vgs of drive transistor 21b is set to VB−VA, Vgs=VB−VA.

Here, data bus signal VB needs to satisfy the formula below. That is, data bus signal VB needs to satisfy the condition for causing a certain amount of drive current Id to flow through drive transistor 21b to the side of the voltage source supplying fixed voltage VA.

VB>VA+Vthmax

where, Vthmax is the maximum threshold voltage of drive transistor 21b.

Fixed voltage VA needs to satisfy the condition, VA<Vf0−ΔVth (where, Vf0 is the emission threshold voltage of organic EL element 21a and ΔVth is the magnitude of the threshold voltage variation of drive transistor 21b), thus generally VA=0V does not cause any problem. But, the use of a higher voltage may reduce the emission transition time of organic EL element 21a, while if ΔVth is large, it is necessary to set VA to a lower voltage (including a negative voltage).

Then, by setting gate-source voltage Vgs of drive transistor 21b to VB-VA, that is Vgs=VB−VA, in the manner as described above, charges remaining in parasitic capacitance 53 of organic EL element 21a are discharged to the fixed voltage source via reset transistor 21e, whereby the potential of the anode terminal of organic EL element 21a eventually becomes 0V.

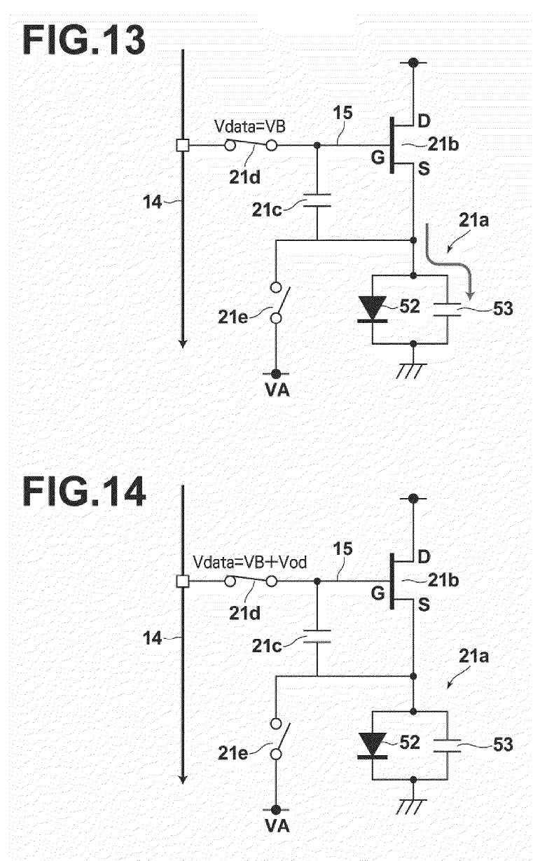

Then, threshold voltage detection is performed (t2 to t3 in FIG. 11 and FIG. 13).

More specifically, an OFF-reset signal like that shown in FIG. 11 is outputted from scan drive circuit 13 to reset scan line 17.

Then, as illustrated in FIG. 13, reset transistor 21e is turned OFF in response to the OFF-reset signal outputted from scan drive circuit 13, and source terminal S of drive transistor 21b is disconnected from the fixed voltage source.

This causes gate-source voltage Vgs of drive transistor 21b to become VB>Vth, Vgs=VB>Vth, and detection current Idd flows through drive transistor 21b according to Vgs. Then, detection current Idd charges parasitic capacitance 53 of organic EL element 21a, and source voltage Vs of source terminal S of drive transistor 11b is increased.

Data bus signal VB supplied to gate terminal G of drive transistor 21b is a fixed voltage, so that Vgs is decreased by the increase in source voltage Vs and detection current Idd is decreased.

Then, the detection current of drive transistor 21b eventually ceases to flow at the time point when source voltage Vs=VB−Vth (time point t3 in FIG. 11).

At this time point, terminal voltage Vcs of capacitor element 21c is, Vcs=Vg−Vs=VB−(VB−Vth)=Vth, thus, threshold voltage Vth of drive transistor 21b is maintained.

Here, in order to keep source voltage Vs below the emission threshold voltage of organic EL element 21a, data bus signal VB needs to have a magnitude that satisfies the formula below. Vthmin in the formula is the minimum threshold voltage of drive transistor 21b.

VB<Vf0+Vthmin

Then, a program operation is performed (t3 to t4 in FIG. 11 and FIG. 14).

More specifically, program data signal Vprg is outputted from data drive circuit 12 to each data line 14. Program data signal Vprg outputted from data drive circuit 12 is inputted to each pixel circuit 21 of the selected pixel circuit row.

Here, program data signal Vprg is,

Vprg=VB+Vod.

Where, Vod is an overdrive voltage of drive transistor 21b, which is Vgs−Vth; that is Vod=Vgs−Vth. Note that Vod is a voltage value signal having a magnitude according to an image to be displayed. That is, a voltage value signal having a magnitude corresponding to a desired amount of emission of organic EL element 21a.

When program data signal Vprg that satisfies the formula above, source voltage Vs of drive transistor 21b is divided by capacitance Cs of capacitor element 21c and capacitance Cd of parasitic capacitance 53 of organic EL element 21a, so that Vs=(VB−Vth)+Vod×{Cs/(Cd+Cs)}, but if Cs <<Cd, then Vod×{Cs/(Cd+Cs)≈0, thus, Vs≈VB−Vth. Therefore, a voltage substantially corresponding to threshold voltage Vth detected by the threshold voltage detection operation plus Vod is set to capacitor element 21c.

The program data signal outputted from data drive circuit 12 is identical to that of the first embodiment.

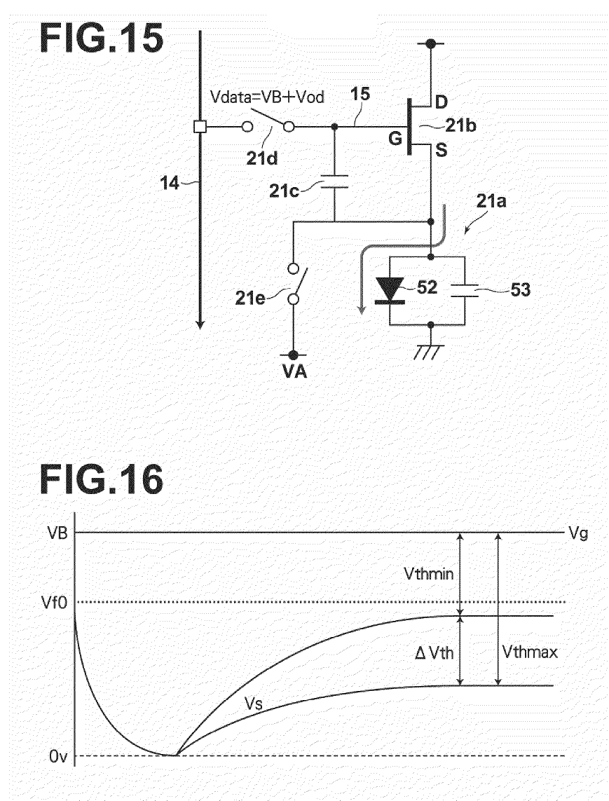

Then, an emission operation is performed (from time point t4 onward in FIG. 11 and FIG. 15).

More specifically, an OFF-scan signal is outputted from scan drive circuit 13 to each scan line 15 (time point t4 in FIG. 11).

Then, as illustrated in FIG. 15, selection transistor 21d is turned OFF in response to the OFF-scan signal outputted from scan drive circuit 13, and gate terminal G of drive transistor 21b is disconnected from data line 14.

Then, gate-source voltage Vgs of drive transistor 21b becomes Vod+Vth, and drive current Idv flows between the drain and source of drive transistor 21b according to the TFT current formula below.

$$\begin{matrix}Idv = μ \times Cox \times ( W \text{/} L ) \times {( Vgs - Vth )}^{2} \\ = μ \times Cox \times ( W \text{/} L ) \times {Vod}^{2}\end{matrix}$$

where, μ is the electron mobility, Cox is the gate oxide film capacitance per unit area, W is the gate width, and L is the gate length.

Parasitic capacitance 53 of organic EL element 21a is charged by drive current Idv, and source voltage Vs of drive transistor 21b is increased, but gate-source voltage Vgs is maintained at Vod+Vth held by capacitor element 21c, so that source voltage Vs exceeds, in due time, emission threshold voltage Vf0 of organic EL element 21a and an emission operation under a constant current is performed by emission section 52 of organic EL element 21a.

Note that, after application of Vod is completed, it is necessary to turn OFF selection transistor 21d by outputting an OFF-scan signal from scan drive circuit 13 to each scan line 15 before source voltage Vs is increased by the increase in the terminal voltage of parasitic capacitance 52 of organic EL element 21a by drive current Idv applied between the drain and source of drive transistor 21b.

Thereafter, pixel circuit rows are sequentially selected by scan drive circuit 13, and the resetting operation to the emission operation are performed in each pixel circuit row, whereby a desired image is displayed.

Also, in the organic EL display device according to the second embodiment, a drive transistor having a current characteristic in which a drive current at Vgs=0V corresponds to an average drive current is used as drive transistor 21b. Preferably, the average drive current is 15% to 50% of the drive current of drive transistor 21b when the organic EL element 11a is at maximum luminance, and more preferably about 20%.

In the organic EL display devices of the first and second embodiments, an n-type thin film transistor of inorganic oxide film, such as IGZO or IZO, as the drive transistor. In particular, where an n-type thin film transistor of IGZO is used as the drive transistor, the reversible threshold voltage shift can be used as described above. For example, when an image having a unique gray balance, unlike a natural image, such as PC screen, CG image, or the like, is displayed for a long period of time and the balance in Vgs between positive/negative biases is disrupted, threshold voltage shift is likely to occur in the drive transistor of organic EL display devices according to the first and second embodiments. But the use of reversible threshold voltage shift of the thin film transistor of IGZO allows the threshold voltage to be returned to the initial value while, for example, a black screen is displayed or power is turned OFF, so that the threshold voltage shift may be prevented.

The embodiments of the present invention described above are embodiments in which the display apparatus of the present invention is applied to an organic EL display devices. But, as for the light emitting element, it is not limited to an organic EL element and, for example, an inorganic EL element or the like may also be used.

The display apparatus of the present invention has many applications. For example, it is applicable to personal digital assistants (electronic notebooks, mobile computers, cell phones, and the like), video cameras, digital cameras, personal computers, TV sets, and the like.

What is claimed is:

1. A display apparatus, comprising an active matrix substrate with an array of multiple pixel circuits, each having a light emitting element, a drive transistor connected to the light emitting element to apply a drive current to the light emitting element, a capacitor element connected between a gate terminal and a source terminal of the drive transistor, and a selection transistor connected between the gate terminal of the drive transistor and a data line for feeding a predetermined data signal,
wherein the drive transistor is an n-type thin film transistor having a current characteristic in which a drive current at a gate-source voltage Vgs=0V corresponds to an average drive current.

2. The display apparatus of claim 1, further comprising a data drive circuit for supplying data signals to the gate terminal of the drive transistor, the signals including both a signal that causes the Vgs of the drive transistor to be positive and a signal that causes the Vgs of the drive transistor to be negative.

3. The display apparatus of claim 1, wherein:
the apparatus further comprises a data drive circuit for supplying a fixed voltage to the gate terminal of the drive transistor; and
a threshold voltage of the drive transistor is held by the capacitor element by charging a parasitic capacitance of the light emitting element by a current flowed through the drive transistor by the supply of the fixed voltage of the data drive circuit.

4. The display apparatus of claim 2, wherein:
the data drive circuit is a circuit that supplies a fixed voltage to the gate terminal of the drive transistor; and
a threshold voltage of the drive transistor is held by the capacitor element by charging a parasitic capacitance of the light emitting element by a current flowed through the drive transistor by the supply of the fixed voltage of the data drive circuit.

5. The display apparatus of claim 1, wherein the average drive current is 15 to 50% of a drive current of the drive transistor when the light emitting element is at maximum luminance.

6. The display apparatus of claim 1, wherein the drive transistor is an n-type thin film transistor of IGZO (InGaZnO).

7. The display apparatus of claim 1, wherein the drive transistor has a negative turn-off threshold voltage and the selection transistor has a positive turn-off threshold voltage.

8. The display apparatus of claim 1, wherein the source terminal of the drive transistor is connected to an anode terminal of the light emitting element.
